(19) United States
(12) Patent Application Publication
(10) Pub. No.: US 2010/0084473 A1
(43) Pub. Date: Apr. 8, 2010

(54) Radio Frequency Identification Tag for the Metal Product with High Thermal Resistance and the Fabricating Method Thereof

(75) Inventor: Kwang-il Choi, Seoul (KR)

Correspondence Address: INTELLECTUAL PROPERTY LAW GROUP LLP, 12 SOUTH FIRST STREET, SUITE 1205, SAN JOSE, CA, 95113, US

(73) Assignee: RF Link Co., Ltd, Seoul (KR)

(21) Appl. No.: 12/097,748

(22) PCT Filed: Jan. 19, 2006
(86) PCT No.: PCT/KR2006/000208

§ 371 Date: Feb. 3, 2009

(30) Foreign Application Priority Data
Dec. 16, 2005 (KR) 10 2005 0124765

(51) Int. Cl. G06K 19/067; H01P 11/00

(52) U.S. Cl. 235/492; 29/600

(57) ABSTRACT

The present invention relates to a radio frequency identification tag having high thermal resistance for metal products and method of manufacturing thereof. The radio frequency identification tag according to the present invention comprises a printed circuit board made of epoxy glass; an antenna pattern and a transponder chip disposed on the upper surface of the printed circuit board; a first thermal resistant ink layer coated on the antenna pattern on the printed circuit board; a metal shielding layer attached to a lower surface of the printed circuit board; a second thermal resistant ink layer coated on the lower surface of the metal shielding layer; and an adhesive layer applied to the second thermal resistant ink layer, wherein a transponder chip protection layer made of thermal resistant is formed on the transponder chip. The radio frequency identification tag according to the present invention, has the advantages of preventing damage to a transponder chip and an antenna pattern even at high temperature environment, being capable of rapidly dissipating heat accumulated in the transponder chip, and being capable of remarkably reducing the likelihood of a transponder chip or an antenna pattern being damaged during the manufacturing process.

### TECHNICAL FIELD

The present invention relates to a radio frequency identification tag for the metal product having high thermal resistance, and a method of fabricating the same. More particularly, the present invention relates to a radio frequency identification tag having high thermal resistance for metal product which can be safely used even in high temperature environment by way of being attached to metal product such as steel plate and a method of fabricating the same.

### BACKGROUND ART

Recently, the use of contactless type cards using a radio frequency identification technology has been increased. Here, radio frequency identification (RFID) technology refers to the technology for communicating in a manner such that if a radio frequency identification tag, comprising a transponder chip embodied in a semiconductor chip and an antenna, is brought close to a reader which transmits a unique frequency, the antenna uses current generated by the radio frequency transmitted by the reader to activate the transponder chip, and transmits information stored in the transponder chip to the reader.

Since this kind of radio frequency identification tag does not require direct contact or line-of-sight scanning, it is convenient to use and it has the advantage of an almost infinite lifespan. Accordingly, use is increasing.

FIG. 1 illustrates an example of a radio frequency identification tag according to the related art. As shown in FIG. 1, an antenna 12 is formed with thin copper wires wound in a elliptical form on a film 10 several times. A transponder chip 14 is disposed inside the antenna 12. The transponder chip 14 is in a chip on board (COB) form, and has connectors 16 on both sides thereof. The connectors 16 are connected with respective ends of the antenna 12 and make the antenna 12 connected to the transponder chip 14.

Generally, the radio frequency identification tag is classified into two types: a hard tag and a soft tag. The hard tag comprises a plastic casing and a coil-type sensing tag embedded in the plastic casing and such hard tags are commonly attached to clothes or luxury goods for security purposes. There is a limit in decreasing the size and the thickness of the plastic casing. Accordingly, the hard tag has a relatively large volume, so that the range of items to which the hard tags can be attached is limited. Further, in order to attach the hard tags to goods, separate attachment means such as pins are needed. Although the hard tag has the above-mentioned disadvantages, the hard tag also has the advantages of not being easily physically damaged and of having high sensitivity.

On the other hand, the soft tag comprises a paper or a vinyl bag made of synthetic resin and a tag received in the bag, and uses a sticker as an attachment means therefor. Accordingly, the soft tag can be realized in a relatively slim and small size, and is relatively easily manufactured. Further, since it is thin and light, it can be attached to or inserted into a variety of goods. Accordingly, it is easy to use and can be applied to a wide range of items such as food, groceries, miscellaneous goods, books, and disks.

FIG. 2 illustrates a cross-section of attaching type of the radio frequency identification tag. The tag comprises a release film 20 provided in the lowermost layer and to be removed when attached, an antenna 24 disposed on the release film 20, and a coating layer 26 made of polyethylene terephthalate (PET) and provided on the antenna 24. The antenna 24 comprises a sheet made of a PET and an aluminum or a copper coil winding on the PET sheet. The coating layer 26 protects the antenna 24 and has a variety of diagrams thereon. The elements including the film 20, the antenna 24 and the coating layer 26 are attached to each other by an adhesive layer 22 interposed therebetween.

However, this kind of tag having the above-mentioned structure is disadvantageous in that it cannot be used at high temperature environment due to the lack of thermal endurance and chemical resistance, which are inherent properties of PET.

In more detail, since PET is thermally deformed at about 250° C., an object made of PET can not be used at a temperature greater than 250° C. In practice, the appearance of radio frequency identification tags made of PET observed to be deformed at about 140° C. or greater.

Accordingly, in the case that products requiring a high temperature environment, such as an aging process during manufacture or management, or in the case that surface of products in itself exhibit high temperature, such tags can not be used. Therefore, it is a matter of urgency to develop an RFID that can be used even at high temperatures environment without malfunction or deterioration.

In order to solve this problem, a tag having high thermal resistance for metal products, in which a plurality of thermal resistant layers are provided on an antenna pattern and a transponder chip, has been developed. This kind of tag has the advantage of excellent thermal endurance, but is disadvantageous in that the thick thermal resistant layers on the transponder chip can cause damage to the transponder chip by preventing heat from dissipating from the transponder chip after heat has been transferred to the transponder chip once during a processing process of metal products to which the tag is applied. Further, the thermal resistant layer forming process is very complex and can cause damage to the transponder chip or the antenna pattern while the process is performed.

In particular, since the transponder chip and the antenna pattern are connected through a wire bonding method or a flip-chip bonding method, the thermal resistant layer forming process can cause damage to the connection between the transponder chip and the antenna pattern.

### DISCLOSURE OF INVENTION

### Technical Problem

Accordingly, the present invention has been devised in consideration of the aforementioned problems and situations, and it is an object of the present invention to provide a radio frequency identification tag having high thermal resistance for metal products, which prevents damage to a transponder chip and an antenna pattern even at high temperatures environment, can rapidly dissipate heat accumulated in a transponder chip, and can reduce the likelihood of a transponder chip and an antenna pattern being damaged during the manufacturing process.

It is another object of the present invention to provide a method of manufacturing the above-mentioned radio frequency identification tag.

### Technical Solution

In order to achieve the above objects and advantages, according to one aspect of the present invention, there is provided a radio frequency identification tag having high thermal resistance for metal products, comprising a printed circuit board made of epoxy glass; an antenna pattern and a transponder chip disposed on the upper surface of the printed circuit board; a first thermal resistant ink layer coated on the antenna pattern on the printed circuit board; a metal shielding layer attached to a lower surface of the printed circuit board; a second thermal resistant ink layer coated on the lower surface of the metal shielding layer; and an adhesive layer applied to the second thermal resistant ink layer, wherein a transponder chip protection layer made of thermal resistant is formed on the transponder chip.

That is, according to the present invention, as a printed circuit board on which transponder chip and antenna pattern is formed, the printed circuit board made of the epoxy glass is used instead of conventional PET sheet. In result, the thermal resistance of the tag is enhanced. Further, by applying thermal resistant ink layer on the printed circuit board, it is possible to reduce the likelihood that the transponder chip and the antenna pattern will be damaged during the manufacturing process, and also to enhance the thermal resistance. Further, since the conventional thermal resistant layer is substituted with thermal resistant ink layer, the thickness of the tag can be decreased, resulting in improvement of the heat sinking characteristic. The printed circuit board is made of epoxy glass known as “FR4”.

In a preferred embodiment, the radio frequency identification tag further comprises a release paper attached to the lower surface of the adhesive layer.

Furthermore, the radio frequency identification tag includes metal shielding layer to prevent degradation of the signal receiving ability of the transponder chip due to metal products. Preferably, the metal shielding layer is made of copper.

According to another aspect of the present invention, there is provided a method of manufacturing a radio frequency identification tag having thermal resistance, comprising the steps of preparing a printed circuit board made of epoxy glass; forming an predetermined antenna pattern on a surface of the printed circuit board; attaching a metal shielding layer on the other surface of the printed circuit board, which is opposite surface on which the antenna pattern is formed; coating thermal resistant ink layers on both surfaces of the printed circuit board except for a portion at which a transponder chip is to be mounted; and attaching a metal shielding layer on the thermal resistant ink layer disposed opposite to the surface on which the antenna pattern is formed.

In a preferred embodiment, the method further comprise the step of forming an adhesive layer on a surface of the metal shielding layer.

Furthermore, the method further comprise the step of attaching a release paper on the adhesive layer.

### Advantageous Effects

The present invention provides a radio frequency identification tag having the advantages of being capable of preventing damage to a transponder chip or an antenna pattern therein even at high temperatures environment, being capable of rapidly dissipating heat accumulated in a transponder chip, and being capable of reducing the likelihood of the transponder chip and the antenna pattern being damaged during a manufacturing process.

### BRIEF DESCRIPTION OF THE DRAWINGS

FIG. 1 is a plan view illustrating a radio frequency identification tag according to the related art;

FIG. 2 is a cross-sectional view illustrating a attaching type of radio frequency identification tag according to the related art;

FIG. 3 is a perspective view illustrating a radio frequency identification tag having high thermal resistance for metal products according to one embodiment of the present invention; and

FIG. 4 is a cross-sectional view illustrating the radio frequency identification tag shown in FIG. 3.

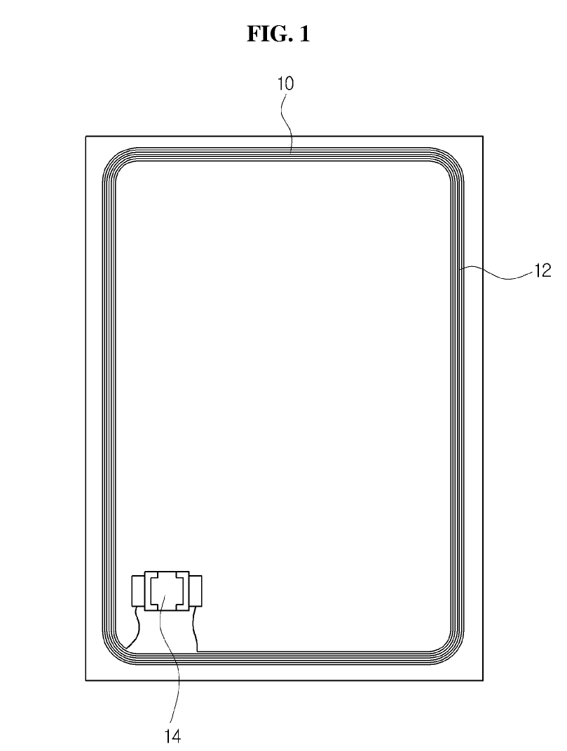

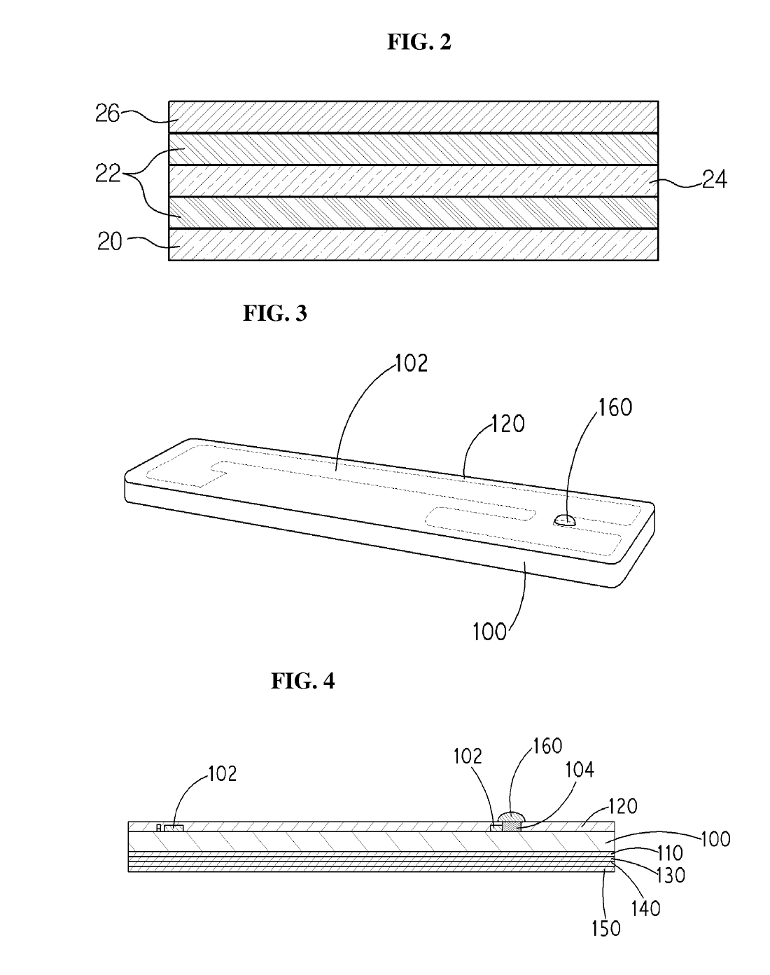

### BEST MODE FOR CARRYING OUT THE INVENTION

Hereinafter, the characteristics and other advantages of the present invention will be more apparent from the following description with reference to the accompanying drawings.

Referring to FIG. 3 and FIG. 4, the radio frequency identification tag having high thermal resistance for metal products includes a printed circuit board 100 instead of a PET sheet, which is a common base material for conventional radio frequency identification tags. The printed circuit board 100 is made of epoxy glass, and serves to shield heat transferred from metal products which are being processed.

An antenna pattern 102 made of copper cladding is formed on the printed circuit board 100, and a transponder chip 104 is also disposed on the printed circuit board 100 with being connected to the antenna pattern 102 via connector.

A metal shielding layer 110 made of copper is attached to the lower surface of the printed circuit board 100. Generally, if a metal piece is disposed close to the antenna pattern in the radio frequency identification tag, the metal piece affects the impedance of the tag, so that the tag cannot resonate properly at a desired frequency. As a result, scattered electromagnetic waves disturb the communication between a reader and a tag. Because the radio frequency identification tags according to this embodiment of the present invention are directed for use in metal products, such events can occur frequently. Accordingly, the metal shielding layer 110 is attached to the lower surface of the printed circuit board 100 in order to prevent such problems from occurring by inhibiting a parasitic signal between a tag and a metal products.

A first thermal resistant ink layer 120 is coated on the surface of the antenna pattern 102 and on the surface of the printed circuit board 100 uncovered by the antenna pattern 102. A second thermal resistant ink layer 130 made of same materials to first thermal resistant ink layer 120 is coated on the lower surface of the metal shielding layer 110. The second thermal resistant ink layer 130 and the first thermal resistant ink layer 120 are formed using the same thermal resistant ink known as PSR. The PSR has thermal resistance in the range of 400 to 500° C. Accordingly, the first and second thermal resistant ink layers 120 and 130 can insulate heat transferred from a metal product or high temperature environment.

In particular, although the first thermal resistant ink layer 120 is very thin, it can effectively insulate against external heat due to its high thermal resistance, and can rapidly scatter heat transferred to the antenna pattern when a heat source is removed.

An adhesive layer 140 with thermal resistance is applied on the lower surface of the second thermal resistant ink layer 130, so that the tag cannot be easily separated from the metal product that is to be managed in high temperature environment. Further, a release paper 150 is provided to a lower surface of the adhesive layer 140 in order to preserve adhesiveness of the adhesive layer 140 during transport and store of the products.

A transponder chip protection layer 160 is provided on the transponder chip 104. The transponder chip protection layer 160 is made of thermal resistant epoxy and has a droplet shape. Because the transponder chip 104 is a kind of semiconductor chip, it is weaker to heat than antenna pattern 102. Accordingly, the protection layer 160 is provided on the transponder chip 104 using epoxy material. The protection layer 160 serves to protect the connection between the transponder chip 104 and the antenna pattern 102 as well as to protect the transponder chip 104 from a heat source.

Hereinafter, a method of manufacturing the radio frequency identification tag according to this embodiment of present invention will be described.

First, a printed circuit board 100 made of epoxy glass having a predetermined sized is prepared. An antenna pattern 102 is formed on a surface of the printed circuit board 100, and a metal shielding layer 110 is attached to the surface of the printed circuit board 100 which is opposite to the surface on which the antenna pattern 102 formed. Then, a thermal resistant ink layer 120 and a second thermal resistant ink layer 130 are applied to both surfaces of the printed circuit board 100. However, the first thermal resistant ink layer 120 is not applied to the portion at which a transponder chip 104 is to be attached.

Next, an adhesive layer 150 and a release paper 160 are attached to the second thermal resistant layer 130, and the transponder chip 140 is then mounted. Then, a protection layer 160 made of thermal resistant epoxy is formed on the transponder chip 140. As is known from the above, since the protection layer 160 is covered after the transponder chip 104 is formed, there is no danger that the transponder chip 104 is damaged or is separated from the antenna pattern 102 during the manufacturing process.

The above-mentioned radio frequency identification tag according to the present invention was tested at high temperatures environment of 250° C. for 1 hour, and deformation of tissues of the printed circuit board, breaking of the printed circuit board, deformation of the adhesive layer, breaking of the adhesive layer, deformation of tissues of the thermal resistant ink, and breakdown of the thermal resistant ink were never observed.

I claim:

1. A radio frequency identification tag having high thermal resistance for metal products, comprising:
a printed circuit board made of epoxy glass;
an antenna pattern and a transponder chip disposed on the upper surface of the printed circuit board;
a first thermal resistant ink layer coated on the antenna pattern on the printed circuit board;
a metal shielding layer attached to a lower surface of the printed circuit board;
a second thermal resistant ink layer coated on the lower surface of the metal shielding layer; and
an adhesive layer applied to the second thermal resistant ink layer,
wherein a transponder chip protection layer made of thermal resistant is formed on the transponder chip.

2. The radio frequency identification tag according to claim 1, further comprising a release paper attached to the lower surface of the adhesive layer.

3. The radio frequency identification tag according to claim 1, wherein the metal shielding layer is made of copper.

4. A method of manufacturing a radio frequency identification tag having thermal resistance, comprising the steps of:
preparing a printed circuit board made of epoxy glass;
forming an predetermined antenna pattern on a surface of the printed circuit board;
attaching a metal shielding layer on the other surface of the printed circuit board, which is opposite surface on which the antenna pattern is formed;
coating thermal resistant ink layers on both surfaces of the printed circuit board except for a portion at which a transponder chip is to be mounted; and
attaching a metal shielding layer on the thermal resistant ink layer disposed opposite to the surface on which the antenna pattern is formed.

5. The method according to claim 4, further comprising the step of forming an adhesive layer on a surface of the metal shielding layer.

6. The method according to claim 5, further comprising the step of attaching a release paper on the adhesive layer.
